(19) United States
(12) Patent Application Publication
(10) Pub. No.: US 2009/0256349 A1
(43) Pub. Date: Oct. 15, 2009

(54) METHOD AND DEVICE FOR CONNECTING TUBES MADE OUT OF THERMOPLASTIC MATERIAL

(76) Inventors: Pierre Strubin, Bellevue (CH); Rene Chuat, Plan-les-Ouates (CH); Yoland Grosjean, Lucena (CH)

Correspondence Address: PAULEY PETERSEN & ERICKSON, 2800 WEST HIGGINS ROAD, SUITE 365, HOFFMAN ESTATES, IL, 60169, US

(21) Appl. No.: 12/265,351

(22) Filed: Nov. 5, 2008

Related U.S. Application Data
(63) Continuation of application No. PCT/EP2007/003351, filed on Apr. 17, 2007.
(60) Provisional application No. 60/798,481, filed on May 5, 2006.

(51) Int. Cl. B29C 65/36; B23K 13/01

(52) U.S. Cl. 285/21.2; 219/617

(57) ABSTRACT

The invention is directed to device and a method to establish a Joint connection (17) with a sleeve (12) comprising at least one susceptor (13, 14) by inductive heating by a welding device (1).

### BACKGROUND OF THE INVENTION

I. Field of the Invention

The invention lies in the field of connecting tubular structures, especially tubular structures made out of thermoplastic material by welding.

II. Description of the Art

Form the prior art several methods are known to connect tubes made out of thermoplastic material.

The aim of JP2005214251A2 is to weld a resin pipe to a connection pipe body in that a connection welding body with a compressed coil spring is attached to an outer circumference part of the connection pipe body onto which a resin pipe is pressed. An induction heating device is placed at a predetermined distance from the coil spring by which an induced current is induced to heat up the coil spring. The heated coil spring extends from the compressed state due to melting peripheral resin. Due to curing of the melted material the resin pipe is welded to the connection pipe body. One problem of this device consists in the difficult preparation and manufacturing of the involved parts.

GB2406303 is directed to an electric welding fitting for connecting end regions of pipelines formed from polymeric material. The welding fitting comprises an electric heating element arranged on the surface of the fitting which in use lies adjacent to the pipeline. An indicator pin is foreseen to indicate the progress of the welding process. The indicator pin is arranged in a recess on a side of the fitting which is remote from the pipeline. The electric welding system of the present device requires an outside connector for the electric coil to supply energy. This is difficult to manufacture and also bears the danger of a weak area in the fitting.

EP1520684 is directed to a welding assembly for forming a welded joint between plastic articles. The assembly comprises first and second inter-connectable plastic articles wherein at least one of the inter-connectable plastic articles is formed from an expandable thermoplastic material. A welding element is disposed between said first and second plastic articles. When said welding element is activated a surface layer of the plastic article expands to reduce any void space between the first and the second plastic article in a welding region. Thereby the first and the second plastic article are fused together to form a welded joint.

US2002170666 is directed to a method of heating a substrate and a coating on the substrate. A susceptor element is applied on the coating, and the element and the substrate are inductively energised to cause the substrate and the coating to be heated.

JP2004052993 is directed to a high frequency induction heating member to join pipes by welding. A high frequency induction heating member dissolves and joins the pipe mainly made of thermoplastic resin by high frequency induction heating. Magnetic metal such as thin-plate shaped iron or stainless steel, etc. is formed into a cylindrical shape or a polygonal shape or the metal is provided with many holes and recessed parts. The metal is held in a gap part of the pipe and is heated by high frequency induction heating to be welded.

U.S. Pat. No. 4,842,305 is directed to a pipe joint for connecting pipes made of non shrinkable plastics such as polybutene. The pipe joint comprises a sleeve body which has a tapered inside surface facing the pipe end and mating the outside surface of the pipe end. A connection is made by heating the joint-forming region, e.g. by a heating element which is embedded in the sleeve body. To make a joint, a sleeve body is made to have a defined taper on its inside surface. A pipe end to be inserted is made to have a corresponding taper on the outside and is inserted into the sleeve body until no clearance is left. A heat source is then energised for a defined time so that the inside surface portions of the sleeve and the outside surface portions of the pipe end melt to form a homogeneous joint after curing.

WO9628683 describes a joint between polymeric coated metal pipelines which is covered with an adhesive lined heat recoverable sleeve positioned to overlie a coating on either side of the joint Prior to recovery of the heat recoverable sleeve onto the coated pipelines a metallic mesh element is positioned over the pipeline coating on either side of the joint. After recovery of the sleeve the entire joint is heated by an induction heater to generate a high temperature not only between the bare pipe in the joint region and the recovered sleeve but also by means of the mesh element between the polymeric coating on the pipelines on either side of the joint and the recovered sleeve.

WO9413457 is directed to a tube and socket which are welded together by inducing a current in an induction member embedded in the weld region. The temperature of the induction member rises until it reaches its Curie temperature; at this point the temperature ceases to rise. The induction member may be embedded in one or both of the spigot and socket or in a separate collar interposed between the two. A welding appliance for inducing current in the induction member may be in the form of a clamp for simultaneously inducing current and clamping the socket onto the spigot. A method of forming a socket makes use of extrusion, and includes steps of expanding a tube end, and retracting it over a collar including an induction member.

EP1369636 is directed to an electric welding sleeve for pipeline connections made of thermoplastic material which is connected to a pipeline by an electric welding process. The electric welding sleeve has two connecting regions connectable to a first and a second pipeline component. The electric welding sleeve is connected to the pipeline component in the first connecting region using an induction welding process.

U.S. Pat. No. 5,462,314 is directed to an electro-fusion fitting with a body which comprises a heater. The heater includes a magnetic alloy unit having a predetermined Curie temperature in the vicinity of a joint surface thereof in a manner that a surface of the heater is exposed to the joint surface. The joint surface of the body is brought into contact with a joint surface of a member to be coupled and, when a high-frequency current is applied to the magnetic alloy unit by electromagnetic induction, the magnetic alloy unit generates heat. The temperature of the magnetic alloy unit is kept at the predetermined Curie temperature due to a temperature self-control function thereof. When the Curie temperature is set at a fusion temperature, the joint surfaces of the body and the member may be coupled to each other.

GB808725 discloses a connecting member made out of thermoplastic material for making a welded lap joint. The connecting member has embedded heating means to effect local softening of the material in that region of the member where the joint is to be made. The heating means may comprise an electrical resistance wire, a metal ring subjected to high frequency induction heating, or a combustible material consisting of cordite accommodated in a hollow ring or in a coiled tube or of a mixture of powdered metal, alloy or silicide and an oxidizing agent, the mixture being self-supporting or placed in a temporary, fusible container. The heating element may be in the form of wire mesh or a loop of wire forming a double start coil.

DE1086426 shows a method to connect two intertwining parts, such as tubes, made of thermoplastic material by induction heating. An electro inductive heatable foil is inserted/arranged between the two intertwining parts and is then heated by inductive heating until the two parts are welded together along their boundary layer.

U.S. Pat. No. 2,739,829 is directed to a plastic pipe joint which is fused to adjacent material of a tube by inductive heating. The pipe joint comprises therefore a non-continuous metal band inserted at the ends of the plastic pipe joint. To insert the tubes into the openings of the pipe joint a swelling agent is applied to increase the diameter of the plastic pipe joint. In that the swelling agent evaporates the diameter is reduced and the plastic pipe joint shrinks onto the tube ends. The metal band is then heated inductively such that the plastic material of the tubes and the plastic pipe joint is fused together. One disadvantage of this method consists in the toxic and therefore dangerous swelling agent and the thereby resulting environmental burden. A further disadvantage is the time consuming method for joining the pipe joint to the pipes.

Induction heating is the process of heating a metal object by electromagnetic induction, where eddy currents are generated within the metal and resistance leads to Joule heating of the metal. An induction heater in general comprises a coil, through which a high-frequency AC is passed. Heat may also be generated by magnetic hysteresis losses.

Induction welding is well known in the prior art for welding of materials by heating through electromagnetic induction. A welding apparatus in general contains an induction coil that is energised with a radio-frequency electric current to generate a high-frequency electromagnetic field. The coil is placed such that the electromagnetic field acts on either an electrically conductive or a ferromagnetic work piece. In an electrically conductive work piece such as steel the main heating effect is resistive heating (magnetically induced currents). In a ferromagnetic work piece, e.g. plastic doped with ferromagnetic particles, heating is caused by hysteresis as the magnetic component of the electromagnetic field repeatedly distorts the crystalline structure of the ferromagnetic material. It is known that plastic materials can be induction welded by implanting them with metallic or ferromagnetic compounds, in general called susceptors, which are heated due to absorption of electromagnetic energy from the induction coil. The control of the temperature in methods and devices known from the prior art is often related to the so called curie temperature of a ferromagnetic material. Thereby the heating element has to be made out of ferromagnetic material. One major disadvantage is that these devices are comparably expensive due to the extensive material cost.

### SUMMARY OF THE INVENTION

It has been found that none of the tube connection methods and devices known from the prior art are satisfying in practical application. A problem that often occurs consists in that it is difficult to achieve connections with a high quality and strength. A further problem consists in that the fittings by which good connections can be achieved are expensive to produce.

It is an object of the present invention to provide an improved method and device to connect structures, especially tubular structures made out of thermoplastic material, by a susceptor. It is a further object of the invention to provide a fitting to be used in the method according to the present invention which provides an improved performance and which can be made at low cost compared to other fittings known from prior art.

The present invention is related to a method and device for the interconnection of products, e.g. profiles, tubes, pipes, fittings, sheaths or any interlocking objects, made at least partially out of a thermoplastic material, such as Polypropylene (PP), Polyethylene (PE) or Polybutene (PB) (other materials may be applicable), by welding in that the material of a first and a second part locally coalesces in a controlled manner. At least one of the parts to be interconnected comprises a metal insert arranged close to a connection surface or is arranged in the connection surface. The metal insert acts as susceptor and is designed such that when inductively heated by a welding device the heat is distributed into the surrounding material of the parts to be connected such that the material fuses superficially in a controlled manner and coalesces in a contact zone. To improve the performance the susceptor is preferably designed as a closed ring into which circumferential currents similar to a transformer-process are inducible by an electromagnetic field. Thereby primary heating results due to circumferential currents and secondary due to local eddy-currents. After curing the two parts are joined together around and across at least one susceptor such that a strong and durable joint results. To improve the mechanical strength the metal insert comprises openings in which base material of at least one part is arranged. Thereby it is achieved, that the metal insert is not only surrounded by the base material but also interspersed by the material which results in better anchorage and finally in a stronger joint connection.

In an embodiment of the invention the metal insert which acts as susceptor has a flat ring-like shape with a certain length in axial direction which is, depending on the field of application, 10 to 30 times larger than the thickness of the ring (outside radius minus inside radius). The susceptor comprises openings extending radially through the metal insert. Depending on the field of application the openings may have a round, triangular or square cross-section. Other cross-sections or combinations thereof are possible. Especially with respect to mechanical strength better results are achieved in that sharp edges are avoided. In a preferred embodiment the edges are therefore rounded of by blends to avoid stress concentrators when the susceptor is embedded in surrounding material. The susceptor is designed to be arranged inside a boundary surface adjacent to said boundary surface and/or slightly below the surface, e.g. depending on the field of application up to 1 mm below the surface.

A sleeve according to the present invention is preferably made by an injection moulding process in a cost efficient manner. Therefore at least one susceptor is arranged as metal insert in contact with an outer surface of a mould onto a core or inside a cavity of said mould. After placing the susceptor in the mould, the mould is closed enclosing the susceptor and then liquefied thermoplastic material is injected into the cavity enclosing the susceptor at least partially. After curing of the plastic material, the mould is opened and the sleeve is removed from the mould such that the process can be started again.

If the susceptor needs to be positioned in the sleeve at a certain distance from the outside wall of the sleeve underneath the surface, the susceptor may comprise positioning means, e.g. in the form of local protrusions which protrude above a surface of the susceptor determining the position between the cavity wall and the susceptor. The positioning means have a certain height in general corresponding to the distance by which the susceptor is arranged from the outside wall. When the susceptor is made out of a thin band of conductive material the positioning means may be shaped e.g. as dimples, lances, tabs, e.g. by punching the thin sheet of material with an appropriate punching tool. However, other positioning means may be appropriate.

The susceptors are sensitive to high frequency electromagnetic induction and are preferably made out of a conductive stainless metal with a certain electrical resistance appropriate to convert the induction field via an electric current into heat Depending on the field of application, other materials such as ferromagnetic materials may be used. However, a disadvantage of susceptors made out of ferromagnetic materials is the significant tendency of corrosion. This can be avoided by the use of antirust material such as stainless steel.

The design of the metal inserts acting as susceptors is optimised such that the heat resulting from inductive heating is distributed in a balanced manner into the surrounding material via the adjacent boundary surfaces of the parts to be joined. In that the susceptors comprise openings they allow passing of the material to be fused such that an optimised hold and perfect fluid tightness result To obtain a well-balanced distribution of the resulting heat the dimensions, the design and the ration between volume and surface of the susceptors is of high relevance (see descriptions of FIGS. 4 to 7). Good results have been achieved in that the susceptors are formed by punching openings into a sheet of conductive material. If appropriate positioning means as described above are made in the same process. To obtain a ring-shaped susceptor the sheet of material is then bent to form a ring. To obtain an even distribution of the heat and electrical conductivity it is advantageous to interconnect the ends of the ring e.g. by welding or another process.

A joint connection between a first and a second part is normally formed around an inductive heatable metal insert which acts as a susceptor, e.g. in form of a closed conductive ring, inserted between the joining surfaces of the parts to be assembled. Primary circumferential and secondary eddy-currents are induced in the susceptor by a field generated of a welding device comprising in general a HF-Generator and a field applicator as described in more detail below. The field applicator of the welding device comprises a coil which can be opened by a plug and a socket such that it can be placed around parts to be joined. By inducing primarily circumferential currents by a transformer effect in the ring-shaped susceptor the temperature of the conductive ring quickly rises. Secondarily local eddy currents are induced which are in this embodiment of minor significance. Depending on the design of the susceptor about 90% of the heat is resulting out of circumferential currents and about 10% out of local eddy currents. The resulting temperature of the susceptor ring is mainly a function of a) the material used (electrical resistance); b) the electromagnetical field applied; c) the shape of the susceptor; d) the thermal conductivity between the susceptor and the surrounding plastic; e) the starting temperature of the parts to be connected; f) the specific heat of the susceptor and the plastic surrounding the susceptor.

In difference to the devices known from the prior art the heating characteristic of a susceptor according to the present invention is determined e.g. in a calorimetric manner in that a susceptor to be measured is positioned in an appropriate liquid, such as water, and then heated by induction. By measuring the temperature change of the liquid the energy trans-formed into heat by the susceptor can be detected sufficiently accurate and the coherence between parameters such as energy transformed into heat, current, voltage, strength of the electromagnetic field, dimensions of the susceptor and time can be determined by experiment and/or calculation. To form a joint connection e.g. between a tube and a sleeve comprising an embedded susceptor the starting temperature of the sleeve is detected and an electric field of a certain strength is applied by a welding device according to the present invention (see below) for a certain time depending from the dimensions and the material of the sleeve, the susceptor and the tube to be interconnected. Alternatively or in addition the characteristics of a susceptor may be determined in a different way, e.g. in that a sensor is applied to a susceptor while testing.

The welding device may comprise or be interconnected to a database means in which information about for the welding process relevant dimensions, sizes and process parameters are stored. The welding device may further comprise an input means e.g. in the form of keyboard and/or a barcode reader and/or an RFID-reader by which it is possible to put in information about and/or identify a specific sleeve to be used in a joint connection. When the specific sleeve to be used is identified, it is possible to retrieve information from the database means about the necessary process parameters. If necessary the welding device further comprises a temperature measuring device by which the present temperature (starting temperature for the welding process) of the sleeve to be used can be determined. Alternatively or in addition relevant information about the sleeve and the process parameters may be stored with the sleeve, e.g. in form of an RFID-tag or a barcode (1- or 2-dimensional barcode). In this case it is not mandatory that the welding device comprises a database means as such. The sleeve may further comprise means to determine the temperature, e.g. in the form of temperature measuring RFID-tag which is capable to transmit present information about the temperature to a receiving means of the welding device. By this it becomes possible to adjust process parameters in accordance to information retrieved from the RFID-tag. Preferably the RFID-tag receives its power from an electrical field, e.g. the field used to weld. By placing the RFID-tag appropriately, e.g. closed by or in direct contact with the at least one susceptor it becomes possible to retrieve information about the welding zone directly.

The welding device may comprise exchangeable collars having different characteristics (sizes, performance). In a preferred embodiment a welding device may be assembled in different configurations out of a kit comprising several collars, at least one handle, at least one HF-generator and/or sensor means and/or input means. The parts of the welding device are preferably interconnected by standardized interconnections which avoid a wrong assembly.

An embodiment of a welding device according to the present invention comprises in general:
A high frequency electromagnetic induction generator (HF-Generator);
a field applicator to apply an electromagnetic field to a first and a second part to be joined/interconnected to each other, whereby the field applicator may comprise multiple loops wire coil enclosed in a flexible collar, which can be opened and closed such that it can be easily positioned e.g. around a long tube;
if appropriate a connector cable for transmission of data and/or a electromagnetic energy between the HF-Generator and the field applicator.

In an embodiment the HF-Generator may be driven by a stationary or a mobile power supply such as a battery pack. The HF-Generator is in general based on an isolated topology using a high frequency transformer which converts a DC voltage link into 20 to 500 kHz frequency AC voltage. For AC line, and depending of the power requested, the DC link may be fed by a PFC stage (Power Factor Compensation stage) allowing sine wave current form in the AC-supply.

In a preferred embodiment the HF-Generator is controlled by a control device, such as a microprocessor, which is interconnected directly or indirectly to sensor means and/or database means and/or an input device, such as described above. The sensor means measure relevant parameters of the welding process, such as the current conduction/flow, the voltage. In an embodiment of the invention the control unit is designed to calculate and thereby control the active power transferred to a susceptor embedded in fusible material of a part indirectly, e.g. without being in direct contact with the susceptor.

To establish a joint connection between a first and a second part via a susceptor the following process steps are in general necessary:
1. Determine process specific information about the parts and the susceptor to be joined and setting the level and the time to apply an alternating electromagnetic field;
2. Applying an alternating electromagnetic field to the susceptor via the coil of the field applicator whereby the field has a certain level. Good results have been achieved with power levels dissipated at the surface of up to 4 W/cm². Thereby a rapid heating of the susceptor and the areas to be fused results. By fast heating it can be avoided that the heat is distributed outside the zone to be fused (this phase can be considered as being mostly adiabatic).
3. When the material to be fused reaches its melting temperature, for polypropylene materials, typically between 260° C. and 300° C., the level of the applied field is reduced and set to a level ensuring that the temperature remains constant in the area of the melted material. Depending on the field of application this normally lasts less than 60 seconds.
4. When sufficient melting of the material is completed the electromagnetic field is removed such that the established joint connection can cure.

An embodiment the invention is directed to a sleeve comprising a carrier made out of injection molded thermoplastic material and at least one susceptor being at least partially embedded in the carrier equidistant to a contact surface of the carrier. To obtain good heating performance the at least one susceptor is ring-shaped. To obtain good heating performance and high mechanical strength in a joint connection the susceptor consists out of perforated metal sheet with openings. In a preferred embodiment the ratio between cross-section of the openings of the perforation and the adjacent solid susceptor surface is in the range of 40% to 65%. The openings of the perforation may be at least partially filled with injection molded plastic material suitable to form bridges in a joint connection between the parts to be joined across the susceptor. The at least one susceptor may be made out of antirust material, such as stainless steel, or aluminum, or titan having a sufficient electrical resistance. In a preferred embodiment the at least one susceptor is arranged flush to the contact surface. Alternatively or in addition the at least one susceptor is arranged at a distance up to 1 mm below the contact surface embedded by injection molded material. To set the position the at least one susceptor comprises protrusions arranged in the direction of a contact surface, said protrusions acting as distance means. The sleeve may comprise a tag carrying information about the characteristics of the at least one embedded susceptor. The tag may be a one or a two dimensional barcode or a RFID-tag. The sleeve may further comprises means to determine the temperature of the at least one susceptor.

The invention is further directed to a welding device to establish a joint connection by a sleeve as described above and a part to be joined. The welding device comprises a coil to generate an electromagnetic field, a HF-generator to drive the coil, and if appropriate a control means interconnected to the HF-generator and/or the coil to control a welding process and an input means to provide the control means with information about the characteristics of a susceptor embedded in the sleeve. Input means may be a barcode reader and/or a keyboard and/or a touch screen and/or a RFID-reading means. The welding device may comprise or may be interconnected to a database means wherein information and characteristics about several sleeves and/or susceptors are stored.

A method according to the invention for establishing a joint connection between at least one part and a sleeve with at least one susceptor and a carrier, comprises in general the following process steps:
a) Positioning the at least one part and the sleeve such that the at least one susceptor is arranged adjacent to a connection surface of the at least one part;
b) Arranging the sleeve and the at least one part in the effective range of a coil of a welding device;
c) Generating an oscillating electromagnetic field by the coil such that a current is induced in the at least one susceptor;
d) Adjusting the level of the electromagnetic field such that the at least one susceptor is heated due to electrical resistance of the material of the at least one susceptor;
e) Applying the electromagnetic field for a certain time until the material of the carrier surrounding the at least one susceptor and the material adjacent to the connection surface of the at least one part melt superficially and join each other;
f) Cooling of the melted material until the material of the sleeve and the at least one part cure and form a joint connection.

### BRIEF DESCRIPTION OF THE DRAWINGS

The herein described invention will be more fully understood from the detailed description given herein below and the accompanying drawings.

FIG. 1 A first embodiment of a welding device with an open collar;

FIG. 2 The welding device according to FIG. 1 with closed collar;

FIG. 3 A temperature diagram;

FIG. 4 A ring-shaped susceptor in a perspective view;

FIG. 5 Detail D of FIG. 4;

FIG. 6 The susceptor according to FIG. 4 in a side view;

FIG. 7 The susceptor according to FIG. 4 in a front view;

FIG. 8 A sleeve in a front view;

FIG. 9 The sleeve according to FIG. 8 in a cut view along Line DD of FIG. 8;

FIG. 10 A mould for making of a sleeve according to FIG. 8;

FIG. 11 A welding device and a susceptor arranged in an electromagnetic field.

### DESCRIPTION OF THE EMBODIMENTS

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

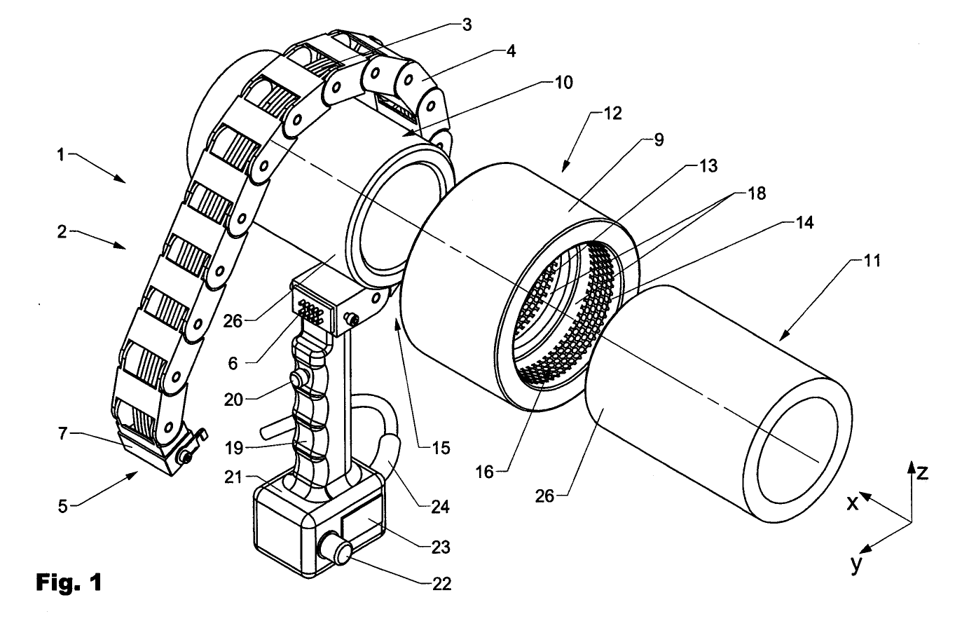

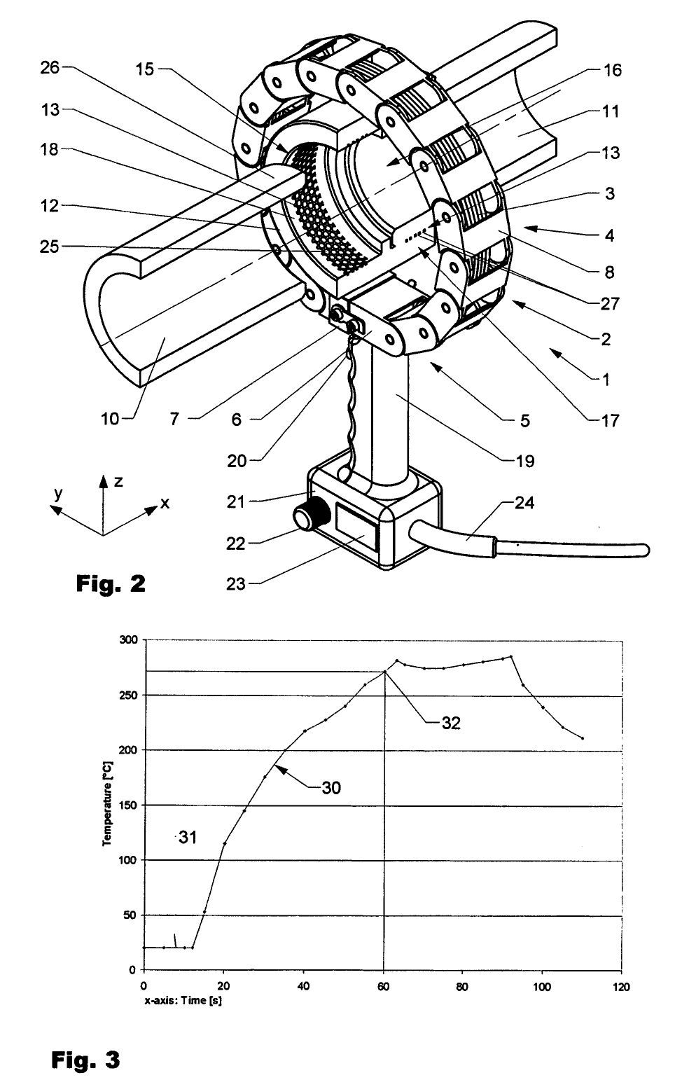

FIGS. 1 and 2 are showing an embodiment of a welding device 1 suitable to establish a joint connection between at least two parts 10, 11, 12 by at least one embedded susceptor 13, 14. The welding device 1 comprises a field applicator 2 with a multi-turn coil 3 arranged within a flexible collar 4, consisting out of pin-jointed collar segments 8, which protects and guides the coil 3. The collar segments 8 are connected to each other such that they can be moved in a plane, here yz-plane. The collar 4 is at one end interconnected to a handle 19 comprising a switch 20 by which the welding process can be controlled. The welding device 1 further comprises or is interconnected to a microprocessor here integrated in a housing 21 and input means 22 to adjust a welding process and/or display means 23 to display information about a welding process. Further the welding device 1 comprises a connector cable 24 by which the welding device 1 is interconnected to a power supply such as a HF-generator (not shown in detail), to supply the AC-power for the magnetic field. If appropriate the electronics and/or control means are integrated in the HF-generator.

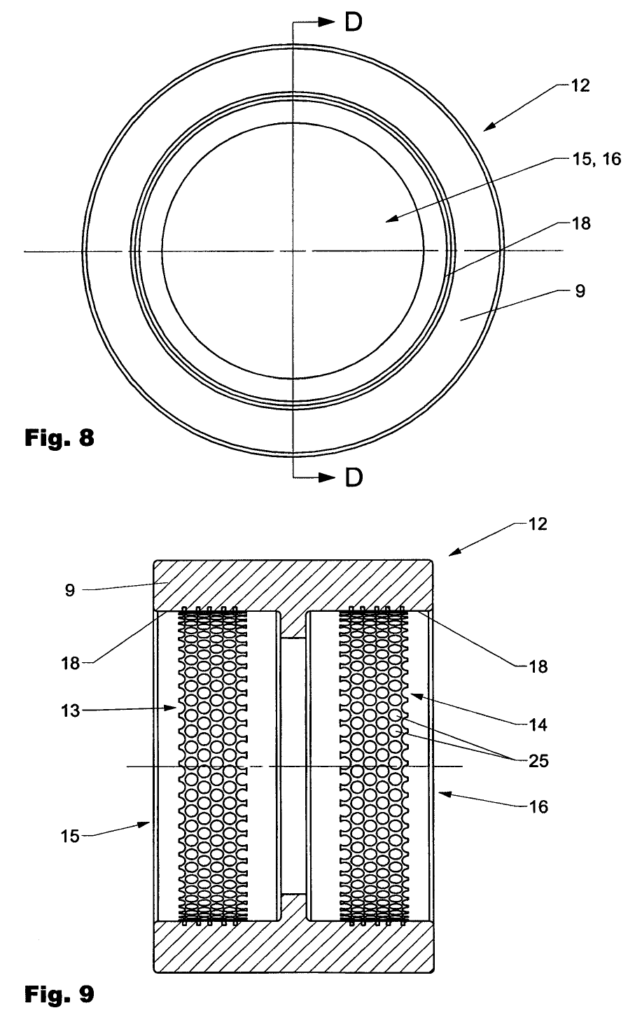

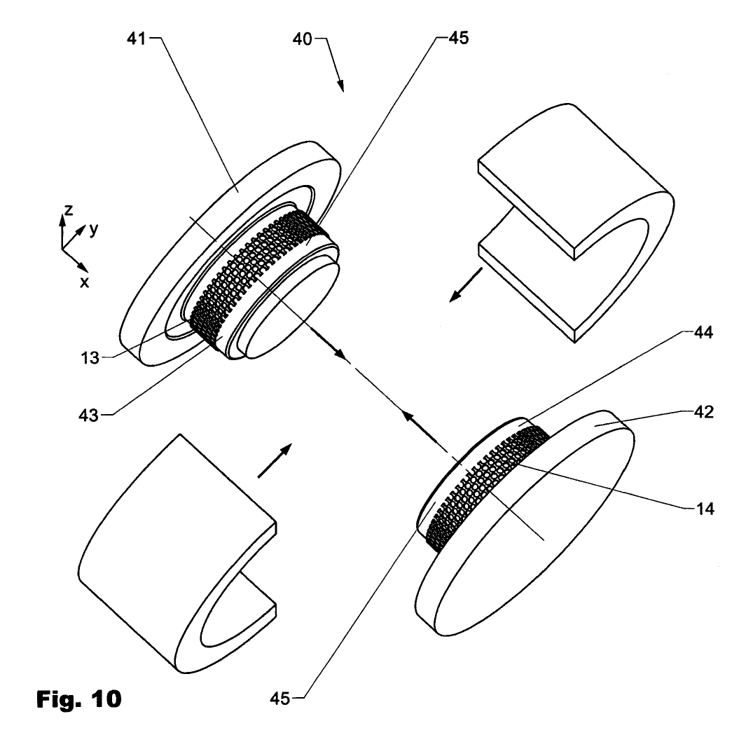

As it can be seen, the field applicator 2 is arranged around a first and a second tube 10, 11 and a sleeve 12. The sleeve 12 comprises a carrier 9 and a first and a second ring-shaped susceptor 13, 14 embedded equidistant to a contact surface 18 of a first and a second opening 15, 16 of the carrier 9. The first and the second tube 10, 11 each comprise at their end arranged closer to the sleeve 12 an outer connection surface 26 having a diameter which corresponds to the inner diameter of the susceptors 13, 14 (see also FIGS. 8, 9).

In FIG. 1 the first and the second tube 10, 11 are arranged coaxially (x-axis) to the sleeve 12 but they are not yet plugged into the openings 15, 16. In FIG. 2 the tubes 10, 11 and the sleeve 12 are shown in a cut-open manner (along xz-plane) such that the inside is visible. The second tube 11 is plugged into the second opening 16 of the sleeve 12 and a joint connection 17 between an outer surface 26 the second tube 11 and the sleeve 12 is already established by a welding process conducted by the welding device 1. The material is joined to each other and the susceptor 14 is fully embedded between the second tube 11 and the sleeve 12. As it can be seen, susceptors 13, 14 of the shown embodiments comprise a perforation with openings 25 which is filled with injection molded plastic material of the carrier 9. Thereby it is achieved that in a joint 17 connection the carrier material arranged in the openings 25 of the perforation form bridges 27 (see FIG. 2) between a first and the second interconnected part 11, 12 across a susceptor 13.

As shown in FIG. 1, the coil 3 and the flexible collar 4 of the welding device 1 can be opened by a connector assembly 5, which comprises a plug 6 and a corresponding socket 7. Thereby it becomes possible to arrange the coil 3 in general coaxially to at least one susceptor 13, 14.

A an embodiment of a HF-Generator (not shown) to drive the welding device 1 via a connector cable 24 comprises in general a transformer which ensures two functions, the first being to match the voltage and current levels with the requirements of the HF-induction process and the second to ensure insulation between the source of energy and the connector cable 24 and the collar 4 ensuring maximum safety for the operator. If appropriate, additional transformers and isolators also ensure full insulation between the control parts and the source of energy. The connector cable is preferably made of multi-conductors some of them for the power transmission and some of them for data transmission such as information relating to interlocking, temperature and type of collar 4. The cable is shielded to satisfy the EMC requirements. The collar 4 comprises a multi-turn air cooled coil surrounded by a flexible and opening protective cover mounted on a handle. The collar 4 of the shown embodiment fulfills among other the following functions. Flexibility to have the ability to shape the outside of the pipes or the parts to be assembled by fusion, this means that the length of the collar 4 is designed to match the parts to be fused. If appropriate the collar is designed exchangeable such that it can be replaced by a different collar 4, resp. coil 3. Opening capability thanks to multiple contacts connectors 5 which allows to surround the parts 10, 11, 12 to be joined and to put the collar 4 in place ready for fusion also after the parts 10, 11, 12 to be joined are completely assembled or to allow an easy longitudinal positioning anywhere along the parts 10, 11, 12 to be joined without interference with possible excrescence or fastening peg. Depending on the design of different embodiments, the collar 4 can e.g. be mounted on an ergonomic handle, with a steady base which may contain at least part of the electronic control and command devices, by mean of a rugged multiple pins connector or a variant is to have a handle for each collar 4. Furthermore, thank to its flexibility, the collar 4 follows closely the geometric shape of the parts 10, 11, 12 to be assembled, ensuring an optimal electromagnetic coupling so as to deliver a symmetric and even heating through a susceptor 13, 14. In addition and thanks to its narrow radiation field and low power requirement, the shown collar 4 does not necessitate a specific shield for the operator. It is intended to be used to apply high frequency electromagnetic induction to susceptors 13, 14 inserted between interlocking surfaces of non conductive meltable or thermoplastic pro files so as to realize a tight fused linkage.

FIG. 3 is showing in a diagram in an exemplary manner the coherence between temperature and time (see graph 30) of a susceptor according to the present invention e.g. embedded in a sleeve when inductively heated by a welding device as displayed in FIGS. 1 and 2. The characteristic of graph 30 further depends on the strength of the magnetic field applied by welding device and the starting temperature 31 (initial temperature of the susceptor, respectively the sleeve surrounding the susceptor). After the coherence between temperature and time has been measured in function of the strength of the magnetic field, the process temperature 32 of a similar susceptor can be determined sufficiently accurate in function of the starting temperature 31, the strength of the magnetic field and the time for how long the magnetic field is applied. This offers the advantage that in a very simple and cost efficient manner it becomes possible to precisely control a welding process although no direct information is retrieved online. Because the temperature is not only a function of the time the electromagnetic field is applied but also from the intensity, the behavior of a susceptor can be best adhered in a three dimensional characteristics (data) diagram where the x-axis is the intensity of the magnetic field, the y-axis is the time the electromagnetic field is applied and the z-axis is the temperature. If appropriate the characteristics diagram can be stored along with a sleeve, e.g. in form of a tag or a matrix bar code capable of holding sufficient information and readable by appropriate reading means such as barcode scanner. Alternatively or in addition, information about several characteristics diagram can be stored in a database which is linked to the welding device such that e.g. by inputting a specific code the appropriate information can be retrieved from the database. Alternatively or in addition a sleeve may be equipped with a RFID-tag which has the ability to measure a relevant temperature and submit it remotely to the welding device. The RFID-tag is preferably powered by the magnetic field applied by the welding device.

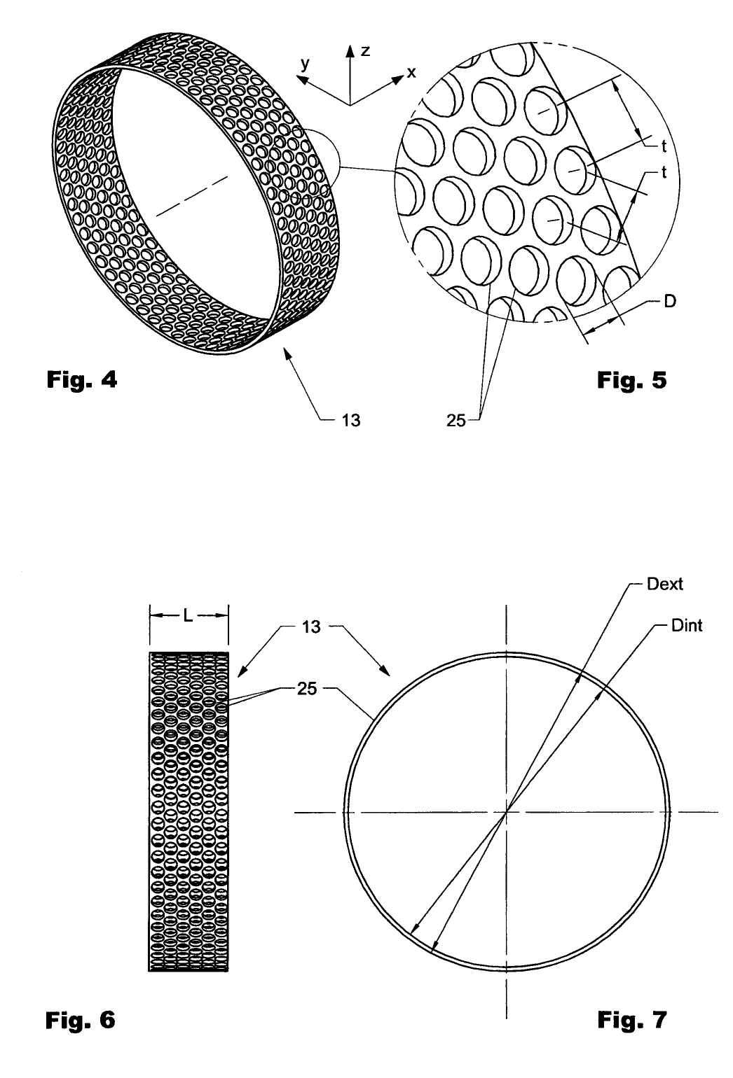

FIGS. 4 to 7 are showing an embodiment of a ring-shaped susceptor 13 as it can be used in a sleeve 12 according to the present invention for e.g. connecting of pipes 10, 11 (see FIGS. 1, 2, 8 and 9). The susceptor 13 is here made out of a perforated metal sheet consisting out of electrically conductible material with a certain resistance. Good results have been achieved with stainless material such as stainless steel. Stainless material has as further advantage that it does not tend to corrosion which has a positive effect on the durability and the strength of the joint connection. The susceptor is preferably shaped endless, which means that in circumferential direction it does not have a hindering face area e.g. in form of a gap where a first and a second end come together. In a preferred embodiment the susceptor is made out of a band of material which is then bent into a ring-shape and the two ends are (electrically) interconnected to each other by welding. Avoiding of negative face areas is insofar relevant as to prevent uneven heating of the susceptor while establishing of a joint connection. A further advantage consists in that an endless evenly shaped susceptor acts as a reinforcing means in the final joint connection.

As it can be seen the shown susceptor 13 has an external diameter Dext and an internal diameter Dint which in general are chosen so that they tightly fit over a tube suitable to be connected. The susceptor 13 has a uniform length L and comprises radial openings 25 having a diameter d. The opening 20 are in the shown embodiment evenly distributed along the circumference of the susceptor 13 spaced apart to each other by a distance t. The following table shows in an exemplary manner dimensions of ring-shaped susceptors. It is clear to one skilled in the art that the scope of the invention is not left by varying the dimensions slightly. Depending on the field of application it is possible to still obtain suitable results by varying the dimensions up to 10% of the Dint

| Tube Diameter | L [mm] | t [mm] | d [mm] | Dint [mm] | Dext [mm] |
|---|---|---|---|---|---|
| 40 | 14.5 | 4 | 3 | 40.1 | 42.1 |
| 50 | 14.5 | 4 | 3 | 50.1 | 52.1 |
| 63 | 18 | 4 | 3 | 63.1 | 65.1 |
| 75 | 21 | 4 | 3 | 75.2 | 77.2 |
| 90 | 24.5 | 4 | 3 | 90.3 | 92.3 |
| 110 | 28 | 4 | 3 | 110.3 | 112.3 |
| 125 | 28 | 4 | 3 | 125.3 | 127.3 |

In a connecting sleeve according to the present invention heat is generated primarily by magnetic induction in a susceptor 13 acting as the heat source which transfers its energy to surrounding thermoplastic material by thermal conduction.

A typical welding process includes in general three phases:
First phase: This phase is here to increase the temperature of the susceptor to a higher temperature than the melting temperature of the thermoplastic. The melting of the thermoplastic will start at the layer of the susceptor. This phase lasts about 50 seconds.
Second phase: The temperature at the susceptor will be stabilized at a convenient temperature to keep on the diffusion of the heat through the thermoplastic, and to melt the surrounding of the susceptor. This phase lasts from 5 to 60 seconds depending on the internal diameter of the fitting and of the temperature of the susceptor the second phase.
Third phase: No more energy is generated in the susceptor. The solidification process starts at the surrounding of the susceptor and the total energy generated by the susceptor will diffuse out of the system until the welded pipe reaches the ambient temperature.

Susceptors are preferably made out of stainless steel or other stainless conductive material, with an appropriate electrical resistance. They are intended to be built-in, placed, inserted or molded in between two thermoplastic or meltable parts to be assembled or, alternatively, in the thickness of one of the two parts wall. These susceptors or inserts have to be punched through to allow the thermoplastic or meltable materials molecules to mix and surround the susceptor during the thermo fusion process, thus creating multiple holding bridges between the two joined parts. These holes or orifices have a very critical shape and side because they play an important role in the overall electromagnetic coupling and the electrical resistance coefficient required for an adequate controlled heating. On the other hand, the remaining surface should be sufficient to evenly diffuse the heat into the adjacent material. Therefore, the acceptable susceptor “transparence” (ratio between the holes and the solid susceptor surface) should preferably be between 40% and 65% according to the considered material.

FIG. 8 is showing a sleeve 12 in a front view and FIG. 9 is showing the sleeve 12 in section view cut along line DD. The sleeve 12 comprises a carrier 9, first and a second opening 15, 16 in which a first and a second susceptor 13, 14 made out of perforated metal sheet are arranged flush to a contact surface 18 of the carrier 9. As it can be seen the openings 25 of the perforation are filled with injection molded plastic material of the carrier 9, thereby it becomes possible to that the material arranged in the perforation establishes in a joint connection bridges with the part to be connected.

Although the first and the second opening 15, 16 have in the shown embodiment the same diameter, it is possible to make a sleeve having openings with different diameters.

It is also possible to design a sleeve as a plug with one opening only. It is furthermore possible to design a sleeve as junction element with more than two openings having the same or different diameters. If appropriate it is possible to equip a sleeve according to the present invention by a valve and/or a pump and/or a measuring device, such as a water meter. Alternatively a sleeve may comprise other connection means in addition or alternatively to at least one susceptor 13, 14 such that the sleeve can be interconnected in a different way, e.g. by a flange or a thread connection.

In difference to the herein shown embodiments a susceptor may also be arranged embedded along an outside surface of a connecting element/sleeve instead of being arranged adjacent to or in an inside surface of a sleeve as described above.

FIG. 10 is schematically showing a mold 40 for making of a sleeve according to the present invention in an open position such that the interior of the mold 40 is visible. The mold 40 comprises a first and an opposite second mold half 41, 42 which are arranged coaxially and displaceable relative to each other in x-direction. The first and the second mold halve 41, 42 each comprise an area, here in form of a first and a second core 43, 44, suitable to temporarily receive at least one susceptor, here a first and a second susceptor 13, 14. A third and a forth lateral mold half 46, 47 are arranged movable with respect to each other in y-direction, at least partially surrounding the first and the second mold half 43, 44 in closed position of the mold 40. In closed position of the mold liquefied plastic material is injected into the cavity formed by the four mold halves 41, 42, 43, 44 forming a carrier of a sleeve according to the present invention enclosing the at least one susceptor at least partially.

The dimensions of the cores 43, 44 are in the shown embodiment such that the susceptors abut a surface 45 of each core 43, 44 and during the subsequent injection molding process, when the mold is closed, no material can enter in between. If appropriate the susceptors 13, 14 may comprise protrusions (not visible) which are arranged in the direction of the surface 45 of the mold 40 acting as distance means to keep the susceptors 13, 14 at a certain distance from the surface 45 during the molding process such that liquefied plastic material can enter during the injection molding process between the susceptor 13, 14 and the surface 45. Thereby the susceptor will be fully enclosed by injected material.

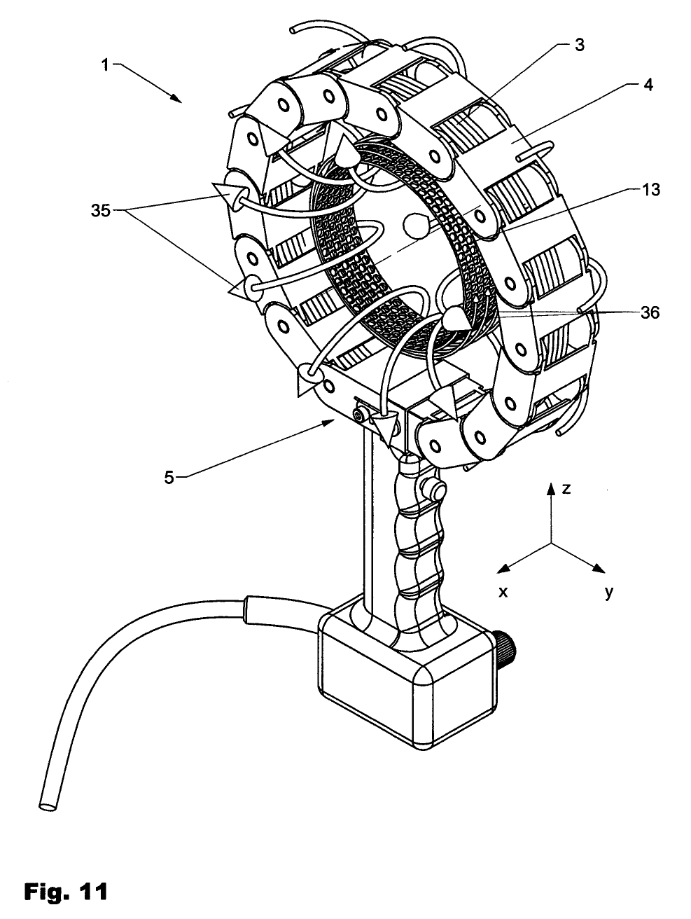

FIG. 11 is showing a welding device 1 and a susceptor 13 arranged in general coaxially to a coil 3 embedded in a collar 4 with respect to x-direction. The susceptor 13 is in general similar to the susceptor 13 as described in accordance with FIG. 4 to 7 and is therefore here not described again. An oscillating electromagnetic field, schematically indicated by first arrows 35 (only one direction shown), is generated by an alternating primary current flowing through the coil 3 of the welding device 1. The field 35 is arranged in general tangential to the coil 3. The susceptor 13 is arranged in the effective range of the field 35 such that an alternating secondary current, schematically indicated by second arrows 36 (only one direction shown), is induced in the susceptor 13 in circumferential direction. Similar to a transformer the susceptor 13 acts as a secondary coil. Such that the susceptor 13 may act as secondary coil it is important that the susceptor forms a closed loop. The primary part of the energy transformed into heat results from the secondary current 36 induced into the susceptor. A minor part of the energy is induced in form of eddy-currents which are having a secondary significance in the shown embodiment. However, other heating may be appropriate depending on the design of the susceptor, e.g. in that heating by eddy-currents may be of major significance.

1. Sleeve (12) comprising a carrier (9) made out of injection molded thermoplastic material and at least one susceptor (13, 14) being at least partially embedded in the carrier (9).

2. The sleeve (12) according to claim 1, characterized in that at least one susceptor (13, 14) is arranged equidistant to a contact surface (18) of the carrier (9).

3. The sleeve (12) according to one of the previous claims, characterized in that the at least one susceptor (13, 14) is ring-shaped.

4. The sleeve (12) according to one of the previous claims, characterized in that the at least one susceptor (13, 14) consists out of perforated metal sheet with openings (25).

5. The sleeve (12) according to claim 2, characterized in that the ratio between cross-section of the openings (25) of the perforation and the adjacent solid susceptor surface is in the range of 40% to 65%.

6. The sleeve according to one of the claims 2 to 5, characterized that the openings (25) of the perforation are at least partially filled with injection molded plastic material suitable to form bridges (27) in a joint connection (17) across the susceptor (13, 14).

7. The sleeve (12) according to one of the previous claims, characterized in that the at least one susceptor (13, 14) is made out of a non-corrosive material.

8. The sleeve (12) according to claim 7, characterized in that at least one susceptor (13, 14) is made out of stainless steel, or aluminum, or titanium.

9. The sleeve (12) according to one of the previous claims, characterized in that the at least one susceptor (13, 14) is arranged flush to the contact surface (18).

10. The sleeve (12) according to one of the claims 1 to 8, characterized in that the at least one susceptor is arranged at a distance up to 1 mm below the contact surface (18) embedded by injection molded material.

11. The sleeve (12) according to claim 10, characterized in that the at least one susceptor comprises protrusions arranged in the direction of a contact surface (18), said protrusions acting as distance means.

12. The sleeve (12) according to one of the previous claims, characterized in that the sleeve (12) comprises a tag carrying information about the characteristics of the at least one embedded susceptor (13, 14).

13. The sleeve (12) according to claim 12, characterized in that the tag is a one or a two dimensional barcode or a RFI Stag.

14. The sleeve (12) according to one of the previous claims, characterized in that the sleeve (12) comprises means to determine the temperature of the at least one susceptor (13, 14).

15. The sleeve according to claim 12, characterized in that the means to determine the heat is a RFID-tag.

16. Welding device (1) to establish a joint connection by a sleeve (12) according to one of the previous claims, characterized by a coil (3) to generate an electromagnetic field field, a HF-generator to drive the coil (3), a control means interconnected to the HF-generator and/or the coil (3) to control a welding process and an input means (22, 23) to provide the control means with information about the characteristics of a susceptor embedded in the sleeve (12).

17. The welding device (1) according to claim 16, characterized in that the input means is a barcode reader and/or a keyboard and/or a touch screen and/or a RFID-reading means.

18. The welding device (1) according to one of the previous claims 16 or 17, characterized in that the welding device comprises or is interconnected to a database means wherein information and characteristics about several sleeves (12) and/or susceptors (13, 14) are stored.

19. Method for establishing a joint connection (17) between at least one part (10, 11) and a sleeve (12), comprising at least one susceptor (13, 14) and a carrier (9), according to one of the claims 1 to 15 comprising the following process steps:
a) Positioning the at least one part (10, 11) and the sleeve (12) such that the at least one susceptor (13, 14) is arranged adjacent to a connection surface (26) of the at least one part (10, 11);
b) Arranging the sleeve (12) and the at least one part (10, 11) in the effective range of a coil (3) of a welding device (1);
c) Generating an oscillating electromagnetic field (35) by the coil (3) such that a current (36) is induced in the at least one susceptor (13, 14);
d) Adjusting the level of the electromagnetic field (35) such that the at least one susceptor (13, 14) is heated due to electrical resistance of the material of the at least one susceptor (13, 14);
e) Applying the electromagnetic field (35) for a certain time until the material of the carrier (9) surrounding the at least one susceptor (13, 14) and the material adjacent to the connection surface (26) of the at least one part (10, 11) melt superficially and join each other;
f) Cooling of the melted material until the material of the sleeve and the at least one part cure and form a joint connection.

20. Method according to claim 19 characterized in that the at least one susceptor has a ring-like shape and is arranged in general coaxial to the coil (3).

21. Method according to one of the claims 19 to 20 characterized in that the carrier material surrounding the at least one susceptor is heated to 240° C. to 300° C.

22. Method according to one of the claims 19 to 21 characterized in that the temperature of the at least one susceptor is determined in function of the intensity and the time of the electromagnetic field applied and the starting temperature.

23. Method according to claim 22 characterized in that the thermal characteristics of the at least one susceptor is determined by a calorimetric method in that the susceptor is inductively heated in a water quench and/or by a sensor interconnected to the susceptor during heating.

24. Method according to one of the claims 22 to 23 characterized in that information about the characteristics of the at least one susceptor is stored in a database means.

25. Method according to one of the claims 22 to 24 characterized in that information about the characteristics of the at least one susceptor is stored in a tag applied to the at least one susceptor.
